(19) United States
(12) Patent Application Publication
(10) Pub. No.: US 2013/0230761 A1
(43) Pub. Date: Sep. 5, 2013

(54) BATTERY MODULE AND BATTERY PACK

(71) Applicants: Oose Okutani, Hyogo (JP); Yoshiaki Kobayashi, Osaka (JP); Shinichi Sakamoto, Osaka (JP)

(72) Inventors: Oose Okutani, Hyogo (JP); Yoshiaki Kobayashi, Osaka (JP); Shinichi Sakamoto, Osaka (JP)

(73) Assignee: PANASONIC CORPORATION, Osaka (JP)

(21) Appl. No.: 13/885,650

(22) PCT Filed: Jun. 29, 2011
(86) PCT No.: PCT/JP2011/003725

§ 371 Date: May 15, 2013

(30) Foreign Application Priority Data
Nov. 30, 2010 (JP) 2010-267464

(51) Int. Cl. H01M 2/20

(52) U.S. Cl. CPC H01M 2/202
USPC 429/158

(57) ABSTRACT

A battery module is provided in which a gap at a bonding section between a positive electrode bus bar and a negative electrode bus bar is less likely to be formed in a bonding process, and stress-induced strain is less likely to be caused at the bonding section after the positive electrode bus bar is bonded to the negative electrode bus bar. The battery module includes a plurality of cells 100 arranged with a same polarity oriented in a same direction, a positive electrode bus bar 200 by which positive electrode terminals of the cells 100 are electrically connected to each other in parallel, and a negative electrode bus bar 300 by which negative electrode terminals are electrically connected to each other in parallel. The positive electrode bus bar 200 includes a flat plate-like extended portion 210 which extends from an edge of the positive electrode bus bar 200 toward the negative electrode terminals, and the negative electrode bus bar 300 includes a bent portion 320 which is bent from an edge opposite to the extended portion 210 toward the negative electrode terminal. In the extended portion 220, a slit 230 is formed at an edge in a width direction perpendicular to an extension direction of the extended portion 220.

### TECHNICAL FIELD

The present invention relates to battery modules which include positive electrode bus bars and negative electrode bus bars and are electrically connected to each other in series, and battery packs.

### BACKGROUND ART

In recent years, as power supplies for mobile units including electric motorbikes, all-electric vehicles (PEVs), hybrid electric vehicles (HEVs), etc., battery packs (assembled cells) in which a plurality of battery modules including a large number of cells are connected to each other in series or in parallel have been used.

In such a battery pack, as illustrated in Patent Document 1 and Patent Document 2, the battery modules are electrically and mechanically connected to each other by conductive members called bus bars.

For example, a positive electrode bus bar connected to a positive electrode current collector plate connected to positive electrode terminals of a plurality of cells included in one battery module is bonded to a negative electrode bus bar connected to a negative electrode current collector plate connected to negative electrode terminals of a plurality of cells included in another battery module, thereby connecting the two battery modules to each other in series (or in series parallel). This process is repeated predetermined number of times to form a battery pack, thereby obtaining a required output voltage.

In such a battery pack, in order to reduce resistance at a bonding section between the positive electrode bus bar and the negative electrode bus bar as much as possible, and to improve the physical strength of the bonding section, increasing the area of the bonding section is effective. Thus, the positive electrode bus bar and the negative electrode bus bar are formed as plate-like members, and the positive electrode bus bar is linearly bonded to the negative electrode bus bar.

### CITATION LIST

### Patent Document

PATENT DOCUMENT 1: Japanese Patent Publication No. 2004-152706
PATENT DOCUMENT 2: Japanese Patent Publication No. 2009-301982

### SUMMARY OF THE INVENTION

### Technical Problem

However, various factors in a fabrication process of positive electrode bus bars and negative electrode bus bars and in an assembling process of battery modules by using the bus bars may lead to positional variations at a bonding section between the positive electrode bus bar and the negative electrode bus bar in a bonding process. When the variations occur, a gap, or the like is formed at the bonding section between the positive electrode bus bar and the negative electrode bus bar, and thus the linear bonding may not be successfully performed.

Moreover, the battery pack in which the positive electrode bus bar and the negative electrode bus bar of the battery modules are bonded to each other is, in many cases, used as a power supply for a mobile unit such as a HEV, and stress-induced strain may be caused at the bonding section between the positive electrode bus bar and the negative electrode bus bar due to vibration, or the like while the mobile unit is moving. When the stress-induced strain is caused at the bonding section, the battery pack may be broken.

In view of the above-discussed problems, the present invention was devised. It is an objective of the present invention to provide battery modules in which a gap at a bonding section between a positive electrode bus bar and a negative electrode bus bar is less likely to be formed in a bonding process, and stress-induced strain is less likely to be caused at the bonding section after the positive electrode bus bar is bonded to the negative electrode bus bar, and a battery pack formed by bonding the battery modules.

### Solution to the Problem

A battery module according to a first aspect of the present invention includes: a plurality of cells arranged with a same polarity oriented in a same direction; a positive electrode bus bar by which positive electrode terminals of the cells are electrically connected to each other in parallel; and a negative electrode bus bar by which negative electrode terminals of the cells are electrically connected to each other in parallel, wherein the positive electrode bus bar has a flat plate-like extended portion which extends laterally to the cells from an edge of the positive electrode bus bar toward the negative electrode terminals of the cells, the negative electrode bus bar has a bent portion which is bent in a direction opposite to the positive electrode terminals of the cells from an edge of the negative electrode bus bar opposite to the extended portion, in the extended portion, a slit is formed at at least one of edges in a width direction perpendicular to an extension direction of the extended portion by cutting out a part of the extended portion in the width direction from the at least one edge toward the other edge, and when the battery module is electrically connected to another adjacent battery module in series to form a battery pack, a top edge of the extended portion of the positive electrode bus bar is bonded to a bent portion of a negative electrode bus bar of the another adjacent battery module.

With this configuration, a slit is formed in the flat plate-like extended portion of the positive electrode bus bar by cutting out a part of the extended portion in the width direction from an edge of the extended portion. Thus, in a bonding process in which the positive electrode bus bar is bonded to the negative electrode bus bar, even when a gap is formed at the bonding section due to positional displacement between the positive electrode bus bar and the negative electrode bus bar, the displacement is corrected when the slit formed in the positive electrode bus bar is narrowed due to deformation of the expanded portion by pressing one battery module and the other battery module against each other so that the battery modules are brought closer to each other, thereby eliminating the gap between the positive electrode bus bar and the negative electrode bus bar.

Moreover, the slit is formed in the flat plate-like extended portion of the positive electrode bus bar, and thus even when stress, such as torsion, is applied to the bonding section in a process after the positive electrode bus bar is bonded to the negative electrode bus bar, the extended portion warps to distribute the stress, so that stress-induced strain is less likely to be caused at the bonding section between the positive electrode bus bar and the negative electrode bus bar.

It is preferable that the slit include slits, and each of the slits be formed at a different one of the edges in the width direction of the extended portion at a different position in the extension direction.

With this configuration, even when stress is applied to any of the edges in the width direction of the flat plate-like extended portion of the positive electrode bus bar, the stress can be relieved in an appropriate manner. Moreover, even when positional displacement such as a projection of any of the edges of the extended portion in the width direction is caused in the bonding process, the gap at the bonding section is appropriately eliminated.

The extended portion is preferably inclined such that a distance of the extended portion from the cells increases toward the negative electrode terminals.

With this configuration, the extended portion extends in a direction oblique to a direction in which the cells are arranged. Thus, in the bonding process in which the positive electrode bus bar is bonded to the negative electrode bus bar, it is easy to eliminate the gap at the bonding section between the positive electrode bus bar and the negative electrode bus bar by pressing one battery module and the other battery module against each other so that the battery modules are brought closer to each other.

It is preferable that an inner end of the slit have an arc shape, or both corners in a width direction at the inner end of the slit have an arc shape.

With this configuration, even when any stress is applied to the inner end of the slit, it is possible to avoid stress concentration on one portion since the inner end has an arc shape, so that a tear from the inner end is less likely to be made. Thus, the positive electrode bus bar is less likely to be broken.

The slit preferably has a length greater than or equal to ¼ and shorter than or equal to ½ of a width of the extended portion.

With this configuration, since the length of the slit has a predetermined length, the above-described function of the slit can be ensured, and it is possible to prevent an increase in electrical resistance at a position where the slit is formed in the positive electrode bus bar.

Alternatively, a width of the flat plate-like extended portion of the positive electrode bus bar may be equal to a width of the bent portion of the negative electrode bus bar.

With this configuration, the width of the extended portion of the positive electrode bus bar is equal to the width of the bent portion of the negative electrode bus bar, and thus a long linear bonding section can be ensured between the positive electrode bus bar and the negative electrode bus bar.

It is preferable that in the extended portion, first and second slits be each formed at a different one of the edges in the width direction perpendicular to the extension direction of the extended portion by cutting out a part of the extended portion in the width direction from one edge toward the other edge at a different position in the extension direction, and a distance between tips of the first and second slits be greater than or equal to a distance in a slit cut-out direction from the tip of a longer one of the first and second slits, or from the tip of any one of the first and second slits when the first and second slits have a same length, to the edge of the extended portion opposite to the edge at which the longer slit, or the any one of the first and second slits is formed.

With this configuration, a sufficiently long distance between tips of the slits is ensured, and thus an increase in electrical resistance between the tips of the slits can be reduced.

The top edge of the extended portion of the positive electrode bus bar is preferably bonded to the bent portion of the negative electrode bus bar of the another adjacent battery module by welding.

With this configuration, due to welding heat, the gap at the bonding section between the positive electrode bus bar and the negative electrode bus bar is less likely to be formed.

A battery pack according to a second aspect of the present invention includes: at least a first battery module and a second battery module which are combined with each other, wherein each of the battery modules includes a plurality of cells arranged with a same polarity oriented in a same direction,

a positive electrode bus bar by which positive electrode terminals of the cells are electrically connected to each other in parallel, and a negative electrode bus bar by which negative electrode terminals of the cells are electrically connected to each other in parallel, wherein the positive electrode bus bar has a flat plate-like extended portion which extends laterally to the cells from an edge of the positive electrode bus bar toward the negative electrode terminals of the cells, the negative electrode bus bar has a bent portion which is bent in a direction opposite to the positive electrode terminals of the cells from an edge of the negative electrode bus bar opposite to the extended portion, in the extended portion, first and second slits are each formed at a different one of edges in a width direction perpendicular to an extension direction of the extended portion by cutting out a part of the extended portion in the width direction from one edge toward the other edge, the first slit is a slit formed at a position closer to the positive electrode terminals of the cells, the second slit is a slit formed at a position closer to the negative electrode terminals of the cells, when the first battery module is electrically connected in series to the second battery module adjacent to the first battery module to form a battery pack, a top edge of the extended portion of the positive electrode bus bar of the first battery module is bonded to the bent portion of the negative electrode bus bar of the second battery module, the first battery module has the first slit at the edge on one side in the width direction perpendicular to the extension direction of the extended portion and the second slit at the edge on the other side in the width direction perpendicular to the extension direction of the extended portion, and the second battery module has the first slit at the edge on the other side in the width direction perpendicular to the extension direction of the extended portion and the second slit at the edge on the one side in the width direction perpendicular to the extension direction of the extended portion.

With this configuration, one battery module and the other battery module are bonded with their slits symmetrically arranged, and thus the stress-induced strain at the bonding section is less likely to be caused.

The top edge of the extended portion of the positive electrode bus bar of the first battery module is preferably bonded to the bent portion of the negative electrode bus bar of the second battery module by welding.

With this configuration, due to welding heat, the gap at the bonding section between the positive electrode bus bar and the negative electrode bus bar is less likely to be formed.

### Advantages of the Invention

According to the present invention, a slit is formed at least one edge of the extended portion of the positive electrode bus bar in the width direction, and thus the gap at the bonding section between the positive electrode bus bar and the negative electrode bus bar in the bonding process is less likely to be formed, and stress-induced strain is less likely to be caused at the bonding section after the positive electrode bus bar is bonded to the negative electrode bus bar.

### BRIEF DESCRIPTION OF THE DRAWINGS

FIG. 1 is a perspective view illustrating an external appearance of a battery module of the present invention.

FIG. 2 is a cross-sectional view illustrating a configuration of a cell.

FIG. 3 is an exploded view illustrating a positional relationship between a positive electrode bus bar, a block spacer, cells, and a battery holder.

FIG. 4 is a perspective view illustrating a configuration of a negative electrode bus bar.

FIG. 5 is a side view illustrating the battery module.

FIG. 6 is a view illustrating how the cells are accommodated in a housing.

FIG. 7 is a view schematically illustrating how battery modules according to the present embodiment are bonded.

FIG. 8 is a perspective view illustrating how one battery module is bonded to the other battery module.

### DESCRIPTION OF EMBODIMENTS

An embodiment of the present disclosure will be specifically described with reference to the attached drawings. The embodiment below is intended for easy understanding of the principle of the present disclosure. The scope of the invention is not limited to the embodiment below, and includes other embodiments expected by those skilled in the art.

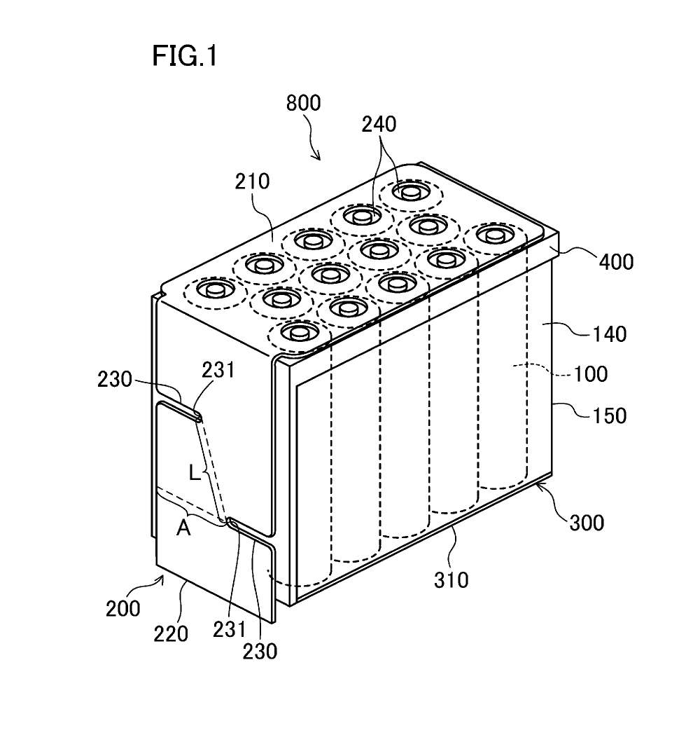

FIG. 1 is a perspective view illustrating an external appearance of a battery module 800 of the present invention. As illustrated in FIG. 1, the battery module 800 includes a plurality of cells 100 arranged with the same polarity oriented in the same direction, a positive electrode bus bar 200 by which positive electrode terminals of the cells 100 are electrically connected to each other in parallel, and a negative electrode bus bar 300 by which negative electrode terminals of the cells 100 are electrically connected to each other in parallel.

The plurality of cells 100 are accommodated in a battery holder 150. The battery holder 150 includes a plurality of battery storage portions 140 in which the cells 100 are accommodated. Each battery storage portion 140 is, for example, a cylindrical hollow portion having a circular cross section so that the battery storage portion 140 can accommodate, for example, a cylindrical cell 100.

The battery storage portions 140 are arranged, for example, in a staggered manner. Here, the expression “staggered manner” means that the plurality of battery storage portions 140 are disposed at regular intervals, and the battery storage portions 140 in adjacent rows are displaced by half the length of the battery storage portion 140 relative to each other. When the battery storage portions 140 are arranged in a staggered manner, space inside the battery holder 150 can effectively be utilized.

The battery holder 150 is formed to include, for example, aluminum, or an aluminum alloy. The aluminum alloy is not particularly limited as long as it is lightweight and has satisfactory thermal conductivity, and for example, an Al—Mg-based alloy, an Al—Mg—Si-based alloy, an Al—Zn—Mg-based alloy, an Al—Zn—Mg—Cu-based alloy, etc. can be used.

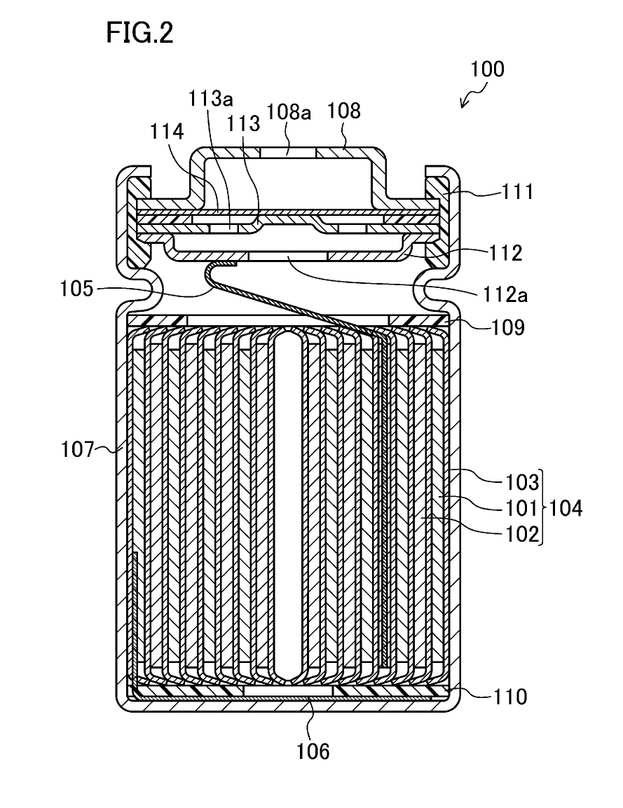

Next, the cell 100 accommodated in each battery storage portion 140 will be described. FIG. 2 is a cross-sectional view schematically illustrating a configuration of the cell 100. As the cell 100, for example, a cylindrical lithium ion secondary battery as illustrated in FIG. 2 can be used. The lithium ion secondary battery has a safety valve mechanism by which gas is released outside the battery when pressure in the battery increases due to the occurrence of an abnormal situation such as an internal short-circuit.

In the cell 100, an electrode group 104 formed by winding a positive electrode 101 and a negative electrode 102 with a separator 103 interposed between the positive electrode 101 and the negative electrode 102 is accommodated in a battery case 107 together with a nonaqueous electrolyte. Insulating plates 109, 110 are respectively disposed above and under the electrode group 104. The positive electrode 101 is bonded to a filter 112 via a positive electrode lead 105, and the negative electrode 102 is bonded to a bottom of the battery case 107 via a negative electrode lead 106, the bottom also serving as a negative electrode terminal.

A paste containing a positive electrode active material and a paste containing a negative electrode active material are applied to a surface of the positive electrode and a surface of the negative electrode, respectively. As the positive electrode active material, one or two or more of positive electrode active materials such as SiMn2O4, SiCoO2, and SiNiO3 used for lithium-ion batteries may be used without particular limitation. As the negative electrode active material, one or two or more of negative electrode active materials such as amorphous carbon and graphite carbon used for lithium-ion batteries may be used without particular limitation. As the nonaqueous electrolyte, for example, ethylene carbonate, propylene carbonate, butylene carbonate, vinylene carbonate, dimethyl carbonate, diethyl carbonate, ethyl methyl carbonate, or the like may be used.

The filter 112 is connected to an inner cap 113, and a raised portion of the inner cap 113 is bonded to a valve plate 114 made of metal. Further, the valve plate 114 is connected to a terminal plate 108 also serving as a positive electrode terminal. The terminal plate 108, the valve plate 114, the inner cap 113, and the filter 112 together seal an opening of the battery case 107 via a gasket 111.

When an abnormal situation such as an internal short-circuit occurs in the cell 100, and pressure in the cell 100 increases, the valve body 114 swells to the terminal plate 108, and a current path is cut when the bonding between the inner cap 113 and the valve body 114 is broken. When the pressure in the cell 100 further increases, the valve body 114 is broken. Thus, gas generated in the cell 100 is released outside via a through hole 112a of the filter 112, a through hole 113a of the inner cap 113, a slit of the valve body 114, and an opening portion 108a of the terminal plate 108.

Referring back to FIG. 1, the positive electrode bus bar 200 includes a top plate portion 210 disposed to face the positive electrode terminals of the cells 100 and having, for example, a flat plate-like shape, and an extended portion 220 extending from an edge of the top plate portion 210 toward the negative electrode terminals of the cells 100.

A plurality of openings 240 corresponding to the cells 100 accommodated in the battery holder 150 are formed in the top plate portion 210. The gas released via the opening portion 108a of the cell 100 is released through a corresponding one of the openings 240.

The extended portion 220 has, for example, a flat plate-like shape, and the dimension of the extended portion 220 may accordingly be determined in consideration of, for example, easiness of bonding the positive electrode bus bar 200 to a negative electrode bus bar 300. For example, the extended portion 220 has a width of 39-42 mm and a length of 60-80 mm, and preferably a width of 40 mm and a length of 70 mm.

A block spacer 400 made of, for example, a resin to prevent electrical conduction between the positive electrode bus bar 200 and the battery holder 150 is provided between (i) the battery holder 150 and (ii) the top plate portion 210 and the extended portion 220.

At an edge of the extended portion 220, a slit 230 is formed as a cut-out in a width direction perpendicular to a direction in which the extended portion 220 extends. The present embodiment includes two slits 230 each of which is formed, for example, at a different edge of the extended portion 220, and at a different level by cutting out parts of the extended portion 220 in the width direction from one edge toward the other edge. Here, the width direction in which the slits 230 are formed by the cutting out includes not only a direction parallel to a top edge located in the direction in which the flat plate-like extended portion 220 extends but also a direction oblique to the top edge. Each slit 230 is formed at a different one of the edges of the extended portion 220. Thus, even when positional displacement which results in, for example, a projection of any of the edges of the extended portion 220 in the width direction is caused in a bonding process, a gap at a bonding section is appropriately eliminated, and even when stress is applied to any of the edges of the extended portion 220 in the width direction in a process after the positive electrode bus bar 200 is bonded to a negative electrode bus bar 300, the stress can be relieved in an appropriate manner. Moreover, each slit 230 is formed at the different edge of the extended portion 220 and at a different level, so that a predetermined length can be ensured as a distance L between tips of the slits 230, and an increase in electrical resistance of the positive electrode bus bar 200 caused by forming the slits 230 can be prevented.

As illustrated in FIG. 1, when the slits 230 have the same length, the distance L between the tips of the slits 230 is preferably greater than or equal to a distance A from the tip of one of the slits 230 to the edge of the extended portion 220 opposite to the edge of the extended portion 220 at which the one of the slits 230 is formed in a cut-out direction of the one of the slits 230. When the distance L between the tips of the slits 230 is short, electrical resistance between the tips of the slits 230 increases, and heat may be excessively generated. However, when the distance L between the tips of the slits 230 is greater than or equal to the distance A from the tip of the slit 230 to the edge of the extended portion 220 in the cut-out direction of the slit 230, the increase in electrical resistance between the tips of the slits 230 can be reduced.

When the slits 230 have different lengths, the distance L between the tips of the slits 230 is preferably greater than or equal to a distance A from the tip of the longer one of the slits 230 to the edge of the extended portion 220 opposite to the edge of the extended portion 220 at which the longer slit 230 is formed in the cut-out direction of the longer slit 230. In this case also the increase in electrical resistance between the tips of the slits 230 can be reduced for a similar reason.

The length of the slit 230 is, for example, greater than or equal to ¼ and shorter than or equal to ½ of the width of the extended portion 220. This is because when the length of the slit 230 is greater than ½ of the width of the extended portion 220, it is possible that the increase in electrical resistance of the positive electrode bus bar 200 at a portion where the slits 230 are formed can no longer be acceptable, whereas when the length of the slit 230 is shorter than ¼ of the width of the extended portion 220, it is possible that it becomes difficult to correct the positional displacement caused in the bonding process in which the positive electrode bus bar 200 is bonded to a negative electrode bus bar 300, and to distribute stress, such as torsion, applied to the bonding section after the positive electrode bus bar 200 is bonded to the negative electrode bus bar 300.

The size of the slit 230 can accordingly be determined in consideration of the function of the slit 230, and is not particularly limited. For example, the slit 230 preferably has a length of 22-26 mm and a width of 2.4-2.6 mm, where the width of the positive electrode bus bar 200 is 40 mm.

An inner end of the slit 230 has, for example, an arc-like shape as illustrated in FIG. 1. The size of the arc-like shape is not particularly limited as long as stress concentration on one portion of the inner end of the slit 230 can be reduced, and for example, the arc-like shape has a radius of 0.5-1.5 mm.

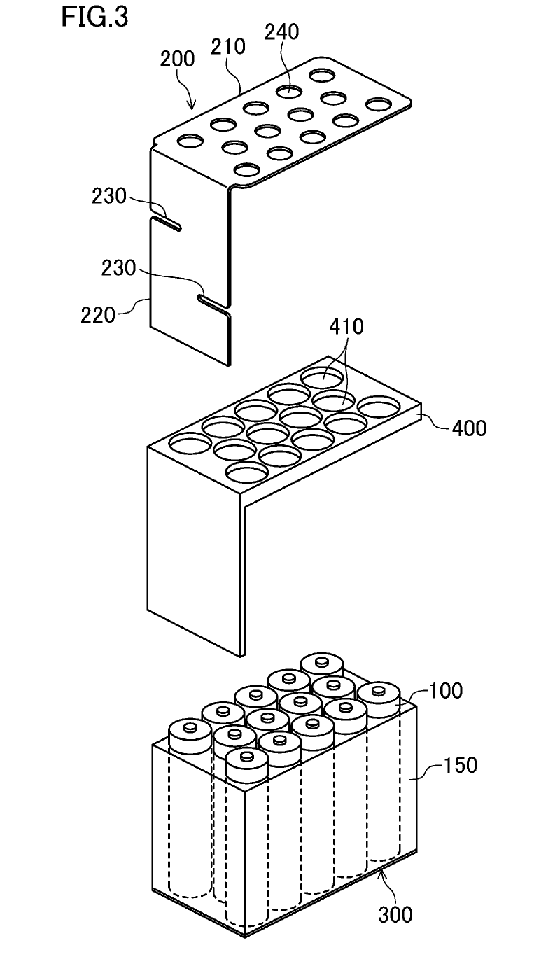

FIG. 3 is an exploded view illustrating positional relationship among the positive electrode bus bar 200, the block spacer 400, the cells 100, and the battery holder 150. As illustrated in FIG. 3, the battery holder 150 has the battery storage portions 140 arranged, for example, in a staggered manner, and in the battery storage portions 140, the cells 100 are accommodated with their positive electrode terminals facing upward.

The block spacer 400 is disposed to face the positive electrode terminals of the cells 100 accommodated in the battery holder 150. A plurality of openings 410 corresponding to the cells 100 are formed in the block spacer 400. The gas released via the opening portion 108a of the cell 100 is released outside through a corresponding one of the openings 410 in the block spacer 400 and the corresponding one of the openings 240 in the top plate portion 210.

The positive electrode bus bar 200 is disposed on the block spacer 400 with the top plate portion 210 facing the positive electrode terminals of the cells 140.

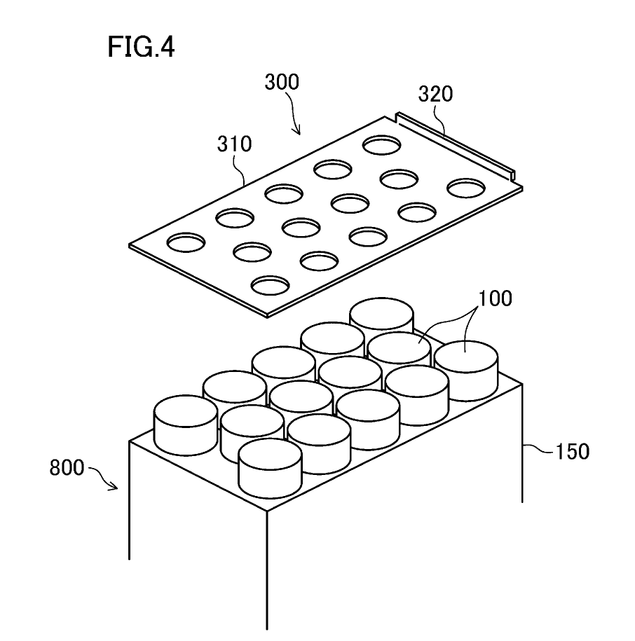

FIG. 4 is a perspective view illustrating a configuration of the negative electrode bus bar 300. As illustrated in FIG. 4, the negative electrode bus bar 300 includes a bottom plate portion 310 which is disposed to face the negative electrode terminals of the cells 100, and has, for example, a flat plate-like shape, and a bent portion 320 which is bent from an edge of the bottom plate portion 310 toward the negative electrode terminals. The bent portion 320 is disposed at an end opposite to an end at which the extended portion 210 of the positive electrode bus bar 200 is disposed. The width direction of the bent portion 320 of the negative electrode bus bar 300 is the same as the width direction of the extended portion 220 of the positive electrode bus bar 200 so that the gap at the bonding section is less likely to be formed when the battery module 800 is bonded to another battery module 800.

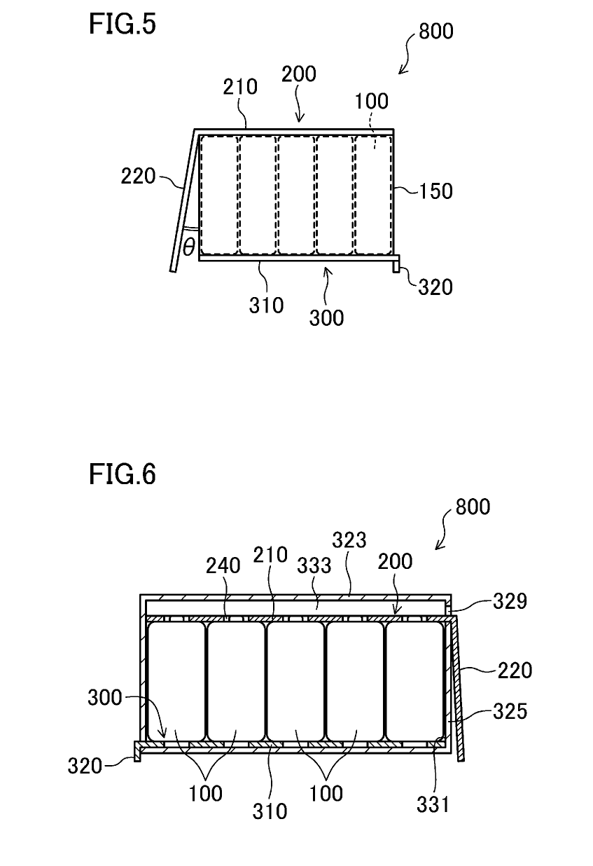

Next, FIG. 5 is a side view of the battery module 800. As illustrated in FIG. 5, the extended portion 220 has a predetermined angel of θ to the longitudinal direction of the cells 100. The extended portion 220 extends in a direction oblique to the longitudinal direction of the cells 100, and thus in the bonding process in which the positive electrode bus bar 200 is bonded to a negative electrode bus bar 300 of the another battery module 800, it is easy to eliminate the gap at the bonding section by pressing the battery modules 800 against each other so that the battery modules 800 are brought closer to each other.

The predetermined angle θ is not particularly limited, and is, for example, greater than 0° and less than or equal to 5°. Note that the block spacer is omitted in the drawing for easy understanding. Moreover, the predetermined angle θ is exaggerated for convenience of understanding the drawing.

Next, disposing the cells 100 accommodated in the battery holder 150 in a housing will be described. FIG. 6 is a view illustrating the disposing the cells 100 in the housing.

As illustrated in FIG. 6, in the battery module 800, the plurality of cells 100, 100, . . . are accommodated in a case. Note that the battery holder 150 is omitted in the drawing for easy understanding. The case is partitioned into a lid body 323 and a housing 325 by the positive electrode bus bar 200. Space defined by the housing 325 and the positive electrode bus bar 200 is a battery chamber 331, and space defined by the lid body 323 and the positive electrode bus bar 200 is an exhaust chamber 333 via which gas is released outside.

In the battery chamber 331, the plurality of cells 100, 100, . . . are accommodated in the housing 325 with their opening portions 108a facing upward, and are arranged in the longitudinal direction of the case. The openings 240 of the positive electrode bus bar 200 are formed at intervals in the longitudinal direction of the positive electrode bus bar 200, and the opening portion 108a of the cell 100 is exposed in each opening 240.

The exhaust chamber 333 has an exhaust port 329. Specifically, a cut-out is formed in one end face in the longitudinal direction of the lid body 323, so that a gap exists between the lid body 323 and the housing 325 at one end in the longitudinal direction of the case, and the gap is the exhaust port 329.

Next, a mode of use of the battery module 800 having the configuration described above will be described.

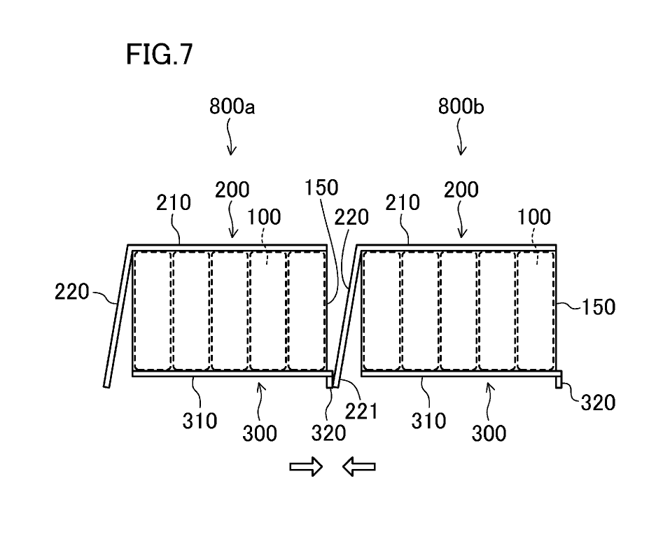

FIG. 7 is a view schematically illustrating how the battery modules 800 according to the present embodiment are bonded. As illustrated in FIG. 7, a top edge 221 of an extended portion 220 of a positive electrode bus bar 200 of one battery module 800b which is closer to negative electrode terminals is placed to face a bent portion 320 of a negative electrode bus bar 300 of the other battery module 800a, and as indicated by arrows in the figure, the battery module 800b and the battery module 800a are pressed against each other so that the battery modules 800b and 800a are brought closer to each other.

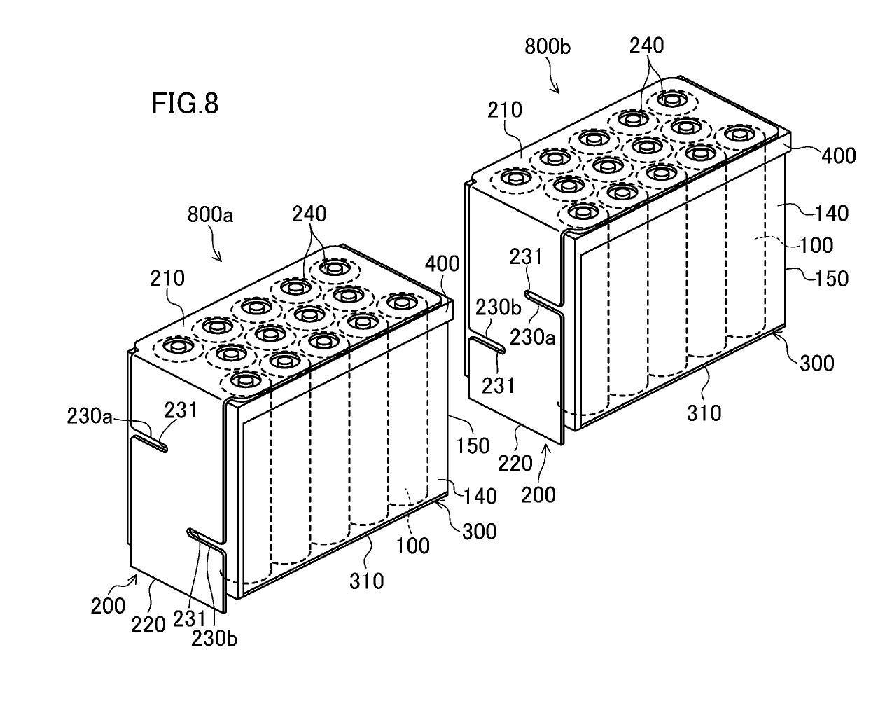

FIG. 8 is a perspective view illustrating how the battery module 800b is bonded to the battery module 800a. As illustrated in FIG. 8, the battery modules 800a and 800b each has a first slit 230a formed at a position closer to the positive electrode terminals of the cells, and a second slit 230b formed at a position closer to the negative electrode terminals of the cells. The battery module 800a has a first slit 230a at an edge on one side (on the left side in FIG. 8) in the width direction perpendicular to an extension direction of the extended portion 220, and a second slit 230b at an edge on the other side (on the right side in FIG. 8) in the width direction perpendicular to the extension direction of the extended portion 220. The battery module 800b has a first slit 230a at an edge on the other side (on the right side in FIG. 8) in the width direction perpendicular to an extension direction of the extended portion 220, and a second slit 230b at an edge on the one side (on the left side in FIG. 8) in the width direction perpendicular to the extension direction of the extended portion 220. A top edge of the extended portion 220 of the battery module 800b which is closer to the negative electrode terminals is bonded to the bent portion 320 of the battery module 800a. Thus, the battery module 800b and the battery module 800a are bonded with their slits symmetrically arranged, and in this case, even when the battery module 800b is under torsion, the torsion can be corrected by the battery module 800a, so that stress-induced strain at the bonding section can further be reduced, which is particularly advantageous when a large number of battery modules are bonded to form a battery pack. The bonding is not particularly limited, but may be mechanical bonding or metallurgical bonding, and is preferably metallurgical bonding. As the metallurgical bonding, welding is preferable. This is because due to welding heat, the gap at the bonding section between the positive electrode bus bar 200 and the negative electrode bus bar 300 is much less likely to be formed. The welding is not particularly limited, and for example, arc welding, gas welding, electroslag welding, thermit welding, laser welding, etc. may be used, and among them, TIG welding is preferable.

In the bonding process, even when a gap is formed at the bonding section due to positional displacement between the positive electrode bus bar 200 of the battery module 800b and the negative electrode bus bar 300 of the battery module 800a, the displacement is corrected when the slits 230 formed in the positive electrode bus bar 200 is narrowed by pressing the battery module 800b and the battery module 800a positive electrode bus bar 200 against each other, so that the gap at the bonding section is eliminated.

Moreover, the slits 230 are formed in the positive electrode bus bar 200. Thus, even when stress, such as torsion, is applied to the bonding section after the positive electrode bus bar 200 is bonded to the negative electrode bus bar 300, the slits 230 distribute the stress, and thus the stress-induced strain is less likely to be caused at the bonding section.

In the embodiment described above, each cell 100 has the safety valve mechanism to release gas outside the battery when pressure in the battery increases due to occurrence of an abnormal state, the openings 240 are formed in the positive electrode bus bar 200 to release the gas outside, and the exhaust chamber 333 is provided through which the gas is released outside when the cell is disposed in the housing. However, the embodiment is not intended to limit the scope of the present invention. An embodiment is possible in which the cell 100 has no safety valve mechanism to release gas outside the cell, no opening 240 is formed in the positive electrode bus bar 200, and no exhaust chamber 333 is provided when the cell is disposed in the housing.

Moreover, in the embodiment described above, the extended portion 220 has the predetermined angle of θ to the longitudinal direction of the cells 100, but such an embodiment is not intended to limit the invention. The extended portion 220 may be provided at a right angle to the top plate portion 210.

### INDUSTRIAL APPLICABILITY

The battery module according to the present invention is useful for power supplies, or the like of mobile electronic devices, mobile communication devices, or vehicles.

### DESCRIPTION OF REFERENCE CHARACTERS

100 Cell
101 Positive Electrode
102 Negative Electrode
103 Separator
104 Electrode Group
105 Positive Electrode Lead
106 Negative Electrode Lead
107 Battery Case
108 Terminal Plate
109, 110 Insulating Plate
111 Gasket
112 Filter
113 Inner Cap
114 Valve Body
140 Battery Storage Portion
150 Battery Holder
200 Positive Electrode Bus Bar
210 Top Plate Portion
220 Extended Portion
230 Slit
240 Opening
300 Negative Electrode Bus Bar
400 Block Spacer
800 Battery Module

1. A battery module comprising:
a plurality of cells arranged with a same polarity oriented in a same direction;
a positive electrode bus bar by which positive electrode terminals of the cells are electrically connected to each other in parallel; and
a negative electrode bus bar by which negative electrode terminals of the cells are electrically connected to each other in parallel, wherein
the positive electrode bus bar has a flat plate-like extended portion which extends laterally to the cells from an edge of the positive electrode bus bar toward the negative electrode terminals of the cells,
the negative electrode bus bar has a bent portion which is bent in a direction opposite to the positive electrode terminals of the cells from an edge of the negative electrode bus bar opposite to the extended portion,
in the extended portion, a slit is formed at at least one of edges in a width direction perpendicular to an extension direction of the extended portion by cutting out a part of the extended portion in the width direction from the at least one edge toward the other edge, and
when the battery module is electrically connected to another adjacent battery module in series to form a battery pack, a top edge of the extended portion of the positive electrode bus bar is bonded to a bent portion of a negative electrode bus bar of the another adjacent battery module.

2. The battery module of claim 1, wherein
the slit includes slits, and
each of the slits is formed at a different one of the edges in the width direction of the extended portion at a different position in the extension direction.

3. The battery module of claim 1, wherein
the extended portion is inclined such that a distance of the extended portion from the cells increases toward the negative electrode terminals.

4. The battery module of any one of claim 1, wherein
an inner end of the slit has an arc shape, or
both corners in a width direction at the inner end of the slit has an arc shape.

5. The battery module of any one of claim 1, wherein
the slit has a length greater than or equal to ¼ and shorter than or equal to ½ of a width of the extended portion.

6. The battery module of any one of claim 1, wherein
a width of the flat plate-like extended portion of the positive electrode bus bar is equal to a width of the bent portion of the negative electrode bus bar.

7. The battery module of claim 2, wherein,
in the extended portion, first and second slits are each formed at a different one of the edges in the width direction perpendicular to the extension direction of the extended portion by cutting out a part of the extended portion in the width direction from one edge toward the other edge at a different position in the extension direction, and
a distance between tips of the first and second slits is greater than or equal to a distance in a slit cut-out direction from the tip of a longer one of the first and second slits, or from the tip of any one of the first and second slits when the first and second slits have a same length, to the edge of the extended portion opposite to the edge at which the longer slit, or the any one of the first and second slits is formed.

8. The battery module of any one of claim 1, wherein
the top edge of the extended portion of the positive electrode bus bar is bonded to the bent portion of the negative electrode bus bar of the another adjacent battery module by welding.

9. A battery pack comprising:
at least a first battery module and a second battery module which are combined with each other, wherein
each of the battery modules includes
a plurality of cells arranged with a same polarity oriented in a same direction,
a positive electrode bus bar by which positive electrode terminals of the cells are electrically connected to each other in parallel, and
a negative electrode bus bar by which negative electrode terminals of the cells are electrically connected to each other in parallel, wherein
the positive electrode bus bar has a flat plate-like extended portion which extends laterally to the cells from an edge of the positive electrode bus bar toward the negative electrode terminals of the cells,
the negative electrode bus bar has a bent portion which is bent in a direction opposite to the positive electrode terminals of the cells from an edge of the negative electrode bus bar opposite to the extended portion,
in the extended portion, first and second slits are each formed at a different one of edges in a width direction perpendicular to an extension direction of the extended portion by cutting out a part of the extended portion in the width direction from one edge toward the other edge,
the first slit is a slit formed at a position closer to the positive electrode terminals of the cells,
the second slit is a slit formed at a position closer to the negative electrode terminals of the cells,
when the first battery module is electrically connected in series to the second battery module adjacent to the first battery module to form a battery pack, a top edge of the extended portion of the positive electrode bus bar of the first battery module is bonded to the bent portion of the negative electrode bus bar of the second battery module,
the first battery module has the first slit at the edge on one side in the width direction perpendicular to the extension direction of the extended portion and the second slit at the edge on the other side in the width direction perpendicular to the extension direction of the extended portion, and
the second battery module has the first slit at the edge on the other side in the width direction perpendicular to the extension direction of the extended portion and the second slit at the edge on the one side in the width direction perpendicular to the extension direction of the extended portion.

10. The battery pack of claim 9, wherein
the top edge of the extended portion of the positive electrode bus bar of the first battery module is bonded to the bent portion of the negative electrode bus bar of the second battery module by welding.
